(19) United States
(12) Patent Application Publication
(10) Pub. No.: US 2024/0259842 A1
(43) Pub. Date: Aug. 1, 2024

(54) SYNCHRONIZATION SIGNAL BLOCK BASED SPECTRUM COEXISTENCE

(71) Applicant: QUALCOMM Incorporated, San Diego, CA (US)

(72) Inventors: Pierpaolo VALLESE, Pineto (IT); Michael Alexander RUDER, Pommelsbrunn (DE); Ebraam Adel KHALIFA, Nürnberg (DE); Mustafa EMARA, Munich (DE); Marco PAPALEO, Bologna (IT)

(21) Appl. No.: 18/160,599

(22) Filed: Jan. 27, 2023

(51) Int. Cl. H04W 24/08; H04W 24/10

(52) U.S. Cl. CPC H04W 24/08; H04W 24/10; H04W 84/12

(57) ABSTRACT

Certain aspects of the present disclosure provide techniques for synchronization signal block (SSB) based spectrum coexistence. An example method, performed at a network entity of a first radio access technology (RAT) network, includes outputting, for transmission, signaling configuring a user equipment (UE) to perform a search and measurement procedure associated with signals on frequency bands that are shared between the first RAT network and a second RAT network, obtaining, from the UE, a report with information indicating results of the search and measurement procedure, and performing one or more actions to mitigate interference based on the information.

### BACKGROUND

### Field of the Disclosure

Aspects of the present disclosure relate to wireless communications, and more particularly, to techniques for mitigating co-channel interference in networks that share frequency bands.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a network entity of a first radio access technology (RAT) network. The method includes outputting, for transmission, signaling configuring a user equipment (UE) to perform a search and measurement procedure associated with signals on frequency bands that are shared between the first RAT network and a second RAT network; obtaining, from the UE, a report with information indicating results of the search and measurement procedure; and performing one or more actions to mitigate interference based on the information.

Another aspect provides a method for wireless communications at a UE. The method includes obtaining signaling, from a network entity of a first RAT network, configuring the UE to perform a search and measurement procedure associated with signals on frequency bands that are shared between the first RAT network and a second RAT network, wherein the first RAT network comprises a wireless wide area network (WWAN), the second RAT network comprises a wireless local area network (WLAN), and the signals comprise synchronization signal blocks (SSBs) compatible with the first RAT network; performing the search and measurement procedure; and outputting, for transmission to the first RAT network entity, a report with information indicating results of the search and measurement procedure.

Another aspect provides a method for wireless communications at a network entity of a second RAT network. The method includes selecting one or more frequency bands that are shared between the second RAT network and a first RAT network; and outputting, for transmission, signals on the selected frequency bands wherein the signals comprise SSBs compatible with the first RAT network.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts a call flow diagram, in accordance with certain aspects of the present disclosure.

FIG. 6 depicts a flow diagram illustrating operations for coexistence, in accordance with certain aspects of the present disclosure.

FIG. 7 depicts a method for wireless communications.

FIG. 8 depicts a method for wireless communications.

FIG. 9 depicts a method for wireless communications.

FIG. 10 depicts aspects of an example communications device.

### DETAILED DESCRIPTION

Aspects of the present disclosure provide apparatuses, methods, processing systems, and computer-readable mediums for mitigating co-channel interference in networks that share frequency bands.

Wi-Fi 6E generally refers to a standard for an extension of the 802.11 ax standard, commonly referred to as Wi-Fi 6. In addition to the currently supported 2.4 GHz and 5 GHz bands, Wi-Fi 6E enables the operation of features in unlicensed 6 GHz band, ranging from 5.925 GHz to 7.125 GHZ, allowing up to 1,200 MHz of additional spectrum.

This increase in available bandwidth may make Wi-Fi 6E a beneficial upgrade to Wi-Fi 6, by providing faster speeds and more capacity, less interference and more precise and efficient use of the available spectrum. These benefits may be particularly useful to support high-bandwidth applications such as streaming, gaming and others.

In the United States, the Federal Communications Commission (FCC) has allocated the entirety of the 6 GHz frequency band (1200 MHz of spectrum) for 5G NR unlicensed operations (NR-U). The European Union (EU) has opened up 480 MHz spectrum in the 6 GHz band (ranging from 5.945 GHz to 6.425 GHz) for Wi-Fi 6E operations. There is currently no coexistence management required with IMT in this portion of the spectrum, as IMT does not include NR-U operating bands.

One possibility under discussion, however, is the allocation of the frequency range 6.425-7.025 GHz to IMT for a certain region (Region 1). This frequency range may be referred to as U6. One possible option under discussion in Europe is the shared use of U6 between IMT and Wi-Fi. One potential challenge in such a scenario, is how to manage the possibility for inter-system co-channel interference.

Aspects of the present disclosure, however, may help manage co-channel interference and allow different networks operating on overlapping frequency bands to co-exist. In some cases, a user equipment (UE) connected to a first network (e.g., an IMT base station) may be configured to perform a search and measurement procedure associated with signals on frequency bands that are shared between the first network and a second network (e.g., Wi-Fi 6E). The UE may then transmit a report indicating results of the search and measurement to the first network. The first network may then perform one or more actions to mitigate interference based on information in the report.

Particular aspects of the subject matter described in this disclosure can be implemented to realize one or more of the following potential advantages. As an example, the techniques herein may help mitigate the impact of co-channel interference. This may allow a greater number of devices enjoy the benefits of increased spectrum, increase overall system performance, and lead to improved user experience.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

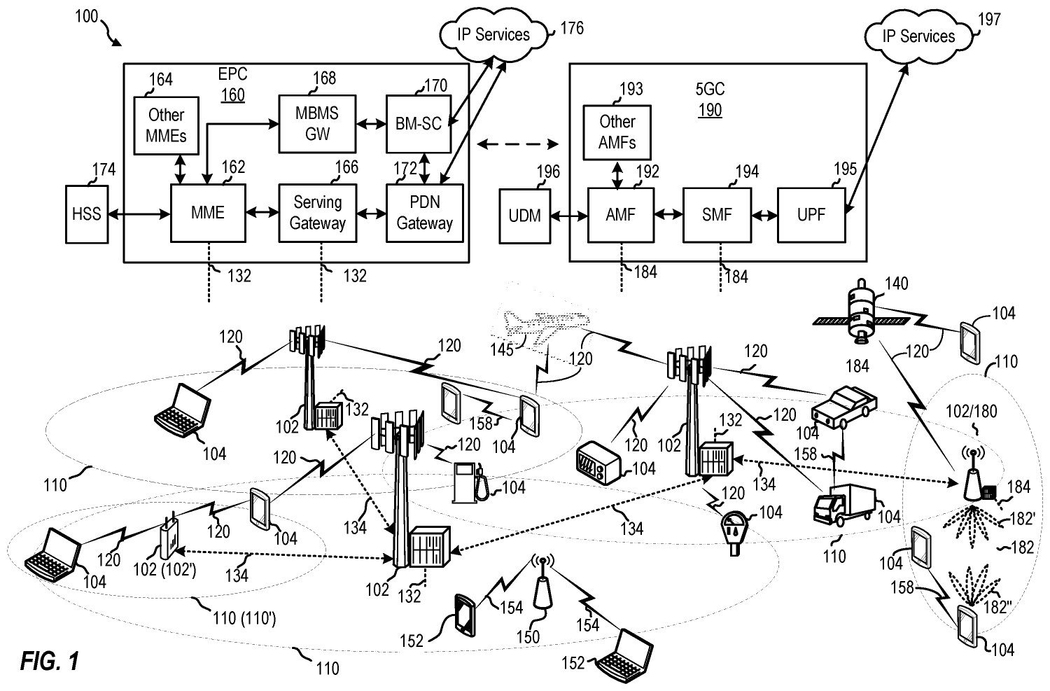

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

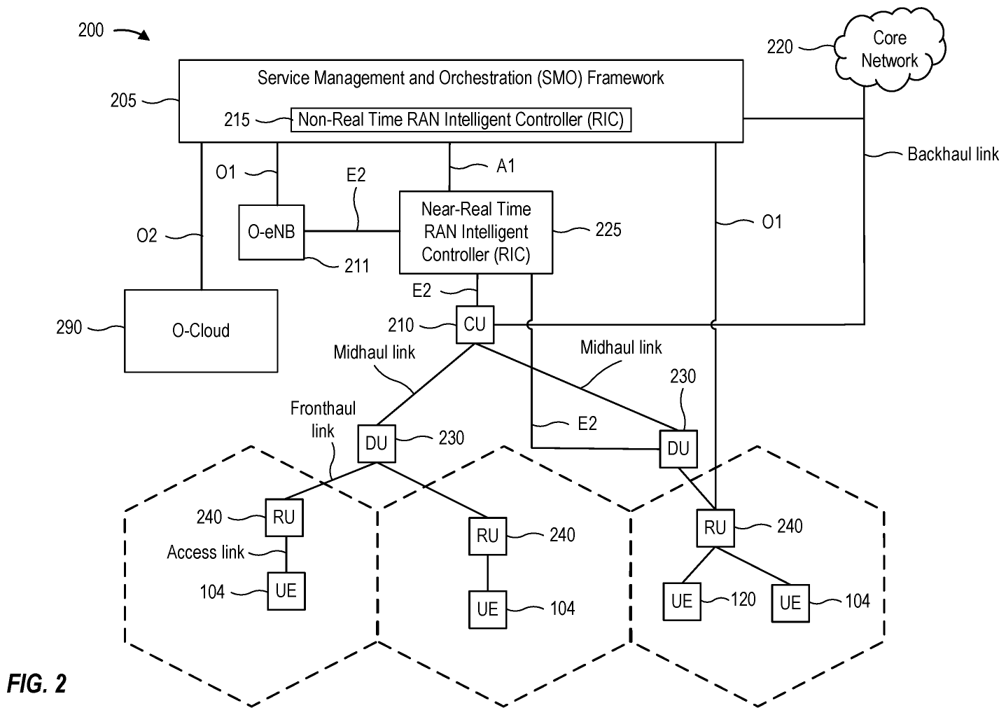

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUS), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHZ, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

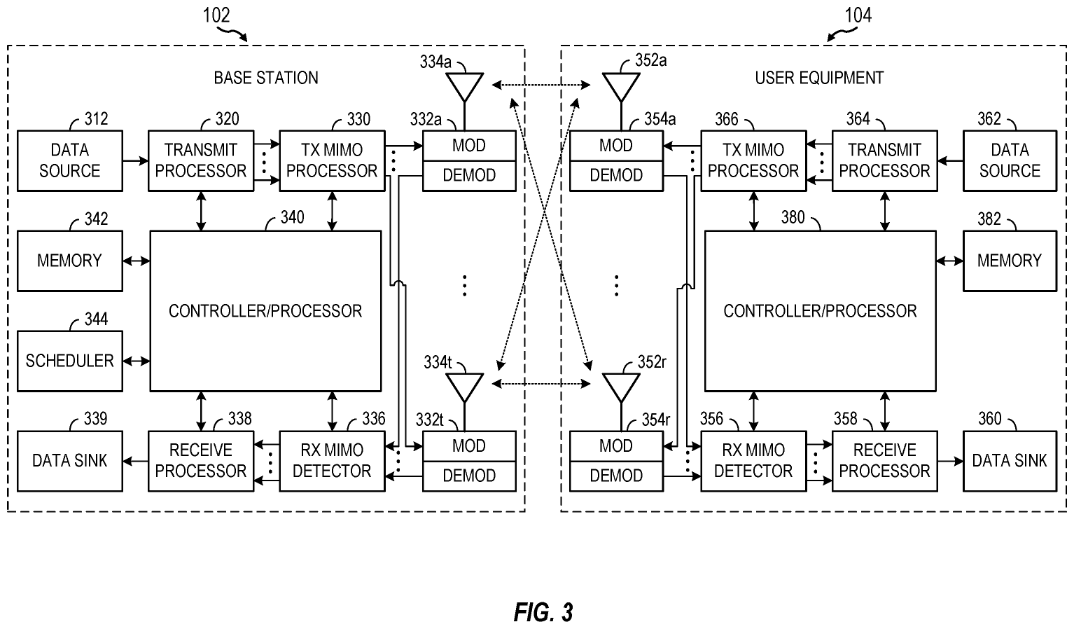

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

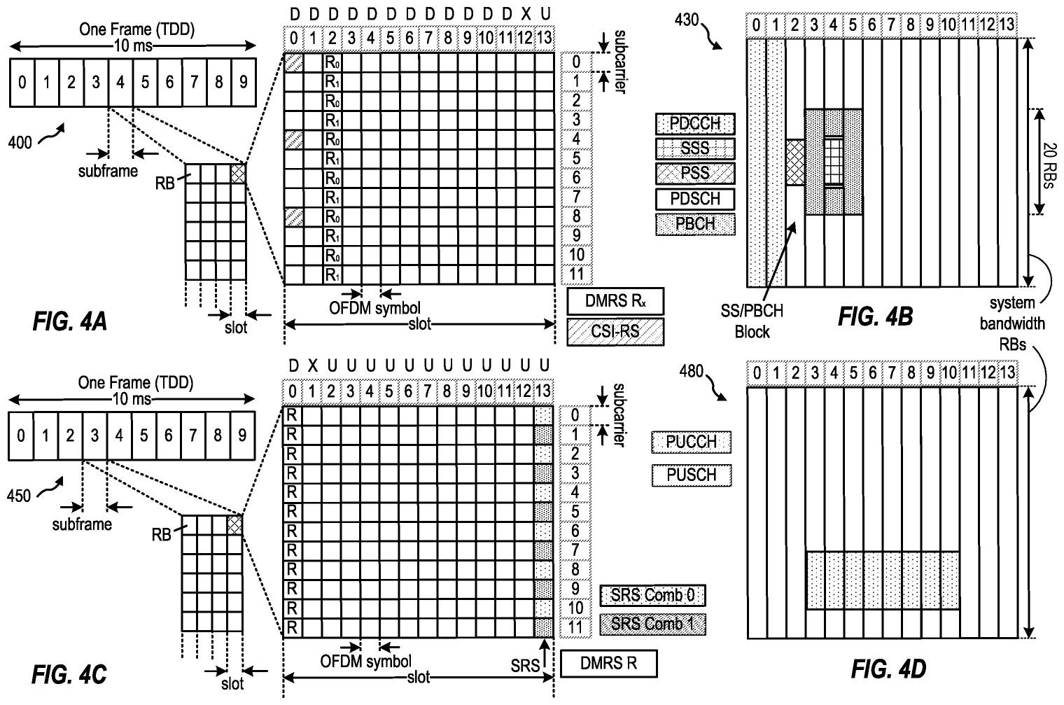

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24× 15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Synchronization Signal Block (SSB) Based Spectrum Coexistence

Aspects of the present disclosure provide apparatuses, methods, processing systems, and computer-readable mediums for mitigating co-channel interference in networks that share frequency bands.

As noted above, an increase in available bandwidth may make Wi-Fi 6E a beneficial upgrade to Wi-Fi 6, by providing faster speeds and more capacity, less interference and more precise and efficient use of the available spectrum. One potential challenge in such a scenario, is how to manage the possibility for inter-system co-channel interference.

To facilitate understanding, the techniques proposed herein are described with reference to example coexistence scenarios of an IMT wireless wide area network (WWAN) and a Wi-Fi 6 wireless local area network (WLAN). The techniques are more broadly applicable, however to any type of wireless network or radio access technology (RAT). Further, the techniques may be broadly applied to mitigate inter-system co-channel interference in any type of overlapping frequency ranges, such as a range from 5.945 GHz to 6.425 GHz for Wi-Fi 6E operations, an IMT range from 6.425 to 7.025 GHz, or even a range from 7.025 to 7.125 GHz.

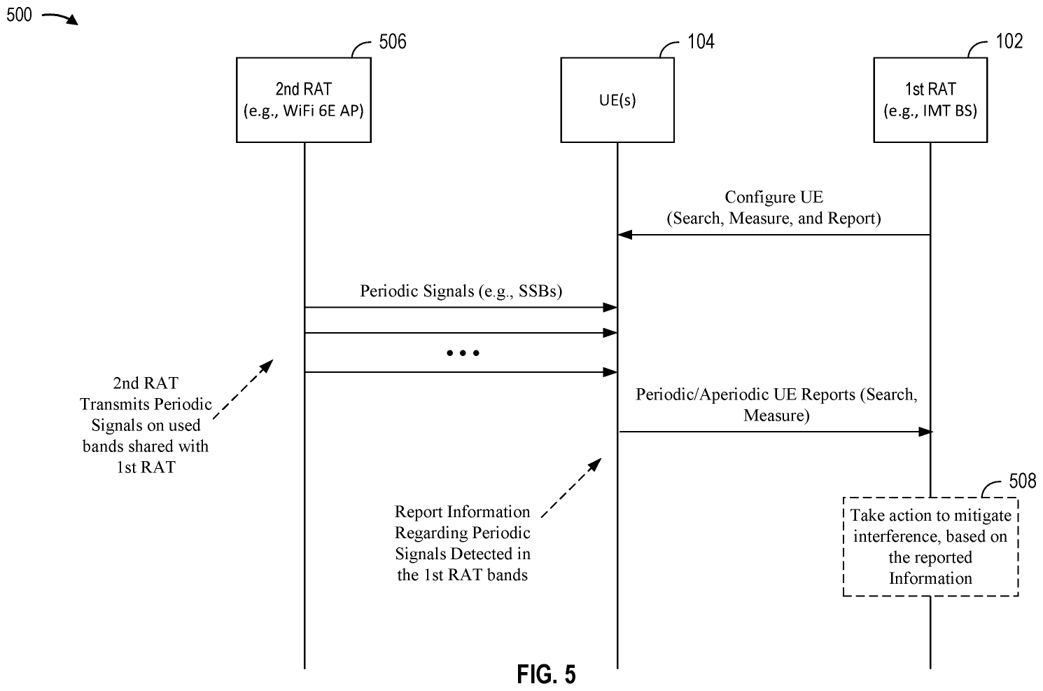

Techniques proposed herein for inter-system co-channel interference may be understood with reference to the call-flow diagram 500 shown in FIG. 5. The network entities shown in FIG. 5 may be examples of base stations 102 depicted and described with reference to FIGS. 1 and 3. UE 104 depicted and described with respect to FIGS. 1 and 3, or a node of disaggregated base station depicted and described with reference to FIG. 2. The UE shown in FIG. 5 may be an example of UE 104 depicted and described with respect to FIGS. 1 and 3.

As illustrated, a first RAT network entity 102 (e.g., an IMT BS) may configure a UE to search, measure, and report periodic signals transmitted by a second RAT network entity (e.g., a WiFi 6E AP). The UE may then search for and measure periodic signals (e.g., SSBs) transmitted in the second RAT.

As illustrated, the second RAT may transmit the periodic signals on bands that are shared with the second RAT. The UE may then transmit periodic or aperiodic UE reports (e.g., based on the search and measurement). The UE reports may provide information regarding periodic signals detected in bands associated with the first RAT (e.g., used bands in the second RAT shared with the first RAT).

The second RAT may then take one or more actions to mitigate interference based on the reported information. For example, the pone or more actions may involve allocating frequency resources to the UE, adjusting transmission power of at least one of the UE or the network entity, terminating a connection with the UE on a frequency band shared between the first RAT network and the second RAT network, or avoiding one or more frequency bands for an amount of time.

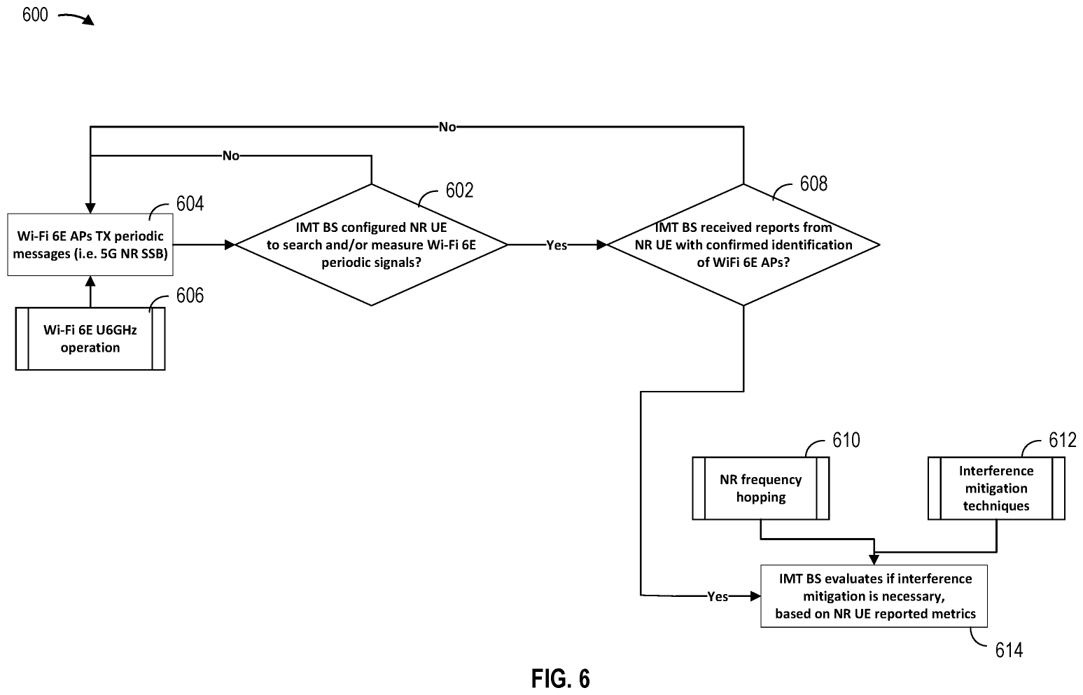

FIG. 6 depicts a flow diagram 600 illustrating a coexistence mechanism for Wi-Fi 6E APs and an IMT BS, in accordance with certain aspects of the present disclosure. In some deployments, Wi-Fi 6E APs transmitting on U6 channels may be limited to indoor applications.

If the IMT BS has not configured an NR UE to search and/or measure Wi-Fi 6E periodic signals, as determined at 602, it may signal Wi-Fi 6E APs to transmit periodic messages (e.g., 5G NR SSBs), at 604, as part of Wi-Fi 6E operation (at 606).

If the IMT BS has configured an NR UE to search and/or measure Wi-Fi 6E periodic signals, the IMT BS may receive reports from the NR UE. In some cases, the report may confirm identification of WiFi 6E APs. As illustrated, the IMT BS may be configured with frequency hopping (610) and interference mitigation techniques (612).

At 614, the IMT BS may evaluate if interference mitigation is necessary, based on NR UE reported metrics.

In this manner, Wi-Fi 6E APs operating in the U6 band may transmit a periodic signal that can be identified and decoded by a 5G NR UE. The signal timing may be assumed to be not synchronized with an IMT BS frame timing or synchronization signal block (SSB) timing.

In some cases, the periodic transmit signal may be a 5G-NR spec compliant SSB (Synchronization Signal Block). Transmission at the AP may be mandated to start at regular intervals to improve detection time and reduce the occupation on the wireless local area network (WLAN) channel. According to certain aspects, transmission start time may be based on system timing, and a minimum accuracy threshold in the time domain for the AP to satisfy may be preconfigured or dynamically configured.

In some cases, the information associated with a 5G NR SSB may be uniquely associated with APs operating in U6. For example, such information may include a Cell Number, Frame Index, master information block (MIB) information, or other system information (SI).

According to certain aspects, frequency location and multiplexing of multiple SSBs in the frequency domain for the AP transmission may be preconfigured or dynamically configured. In some cases, such configurations may be determined based on a trade-off between complexity and finer spectrum control.

According to certain aspects, transmission of the periodic signals may be voided (not sent), for example, if Wi-Fi conditions do not allow for channel access (e.g., the channel is sensed as busy), and SSB transmission by the AP may be considered as a ‘Best Effort.’

According to certain aspects, the waveform for the periodic signal may be fixed. In such cases, the APs may not be expected to modify the transmitted signal periodically. A replay of the copy (or one of different copies), potentially resampled, and stored in the AP memory may be used for transmission purposes.

UEs connected to IMT Base Stations on U6 bands, when configured to do so by the IMT BS, may search, measure, and report the identification of periodic signals transmitted by Wi-Fi 6E APs in U6 frequencies, if such periodic signals can be sensed within their operational range.

IMT operations already provide a framework for Search and Measurement of SSBs, following network configuration of a request to the UE. Search and Measurements of Neighboring SSBs (e.g., where neighboring may mean that an SSB is not transmitted by the 5G NR BS the UE is connected to) is a conventional and expected behavior for UEs operating in 5G NR.

In some cases, the Search configuration type for the UE may be Asynchronous, assuming no frame-timing synchronization between IMT and Wi-Fi APs. According to certain aspects, IMT may be informed through scheduled Measurement reports and may identify unique AP SSBs reported fields.

According to certain aspects, measurements may be requested and received before the UE is allocated on the U6 band, through Inter-Band SSB Measurement procedures, on target frequencies chosen by the BS that are not restricted to bandwidths used by the BS.

As described above, IMT Base Stations may receive such information from connected UEs and decide, based on the metrics reported for the periodic signal, whether it is allowed to allocate frequency resources on U6 to the target UE (e.g., in order to avoid excessive levels of interference to the Wi-Fi network operating in proximity of the UE) or if other mitigation techniques should be employed.

According to certain aspects, an IMT BS may be mandated to apply interference management schemes. Such inference management schemes may include (but are not limited to), for example, a transmission power reduction for a UE or BS, dropping a UE connection in U6 band, or vacating the frequencies in locations sensed as occupied by APs for a determined amount of time before a new attempt at connection.

The interference management techniques and operational parameters described above, may be based on dynamic measurements reporting of one or more parameters. For example, such parameters may include: measured Received Signal Strength Indicator (RSSI), Reference Signal Received Power (RSRP), Signal to Interference and Noise Ratio (SINR), UE velocity and movement, historical data from other sources, or other data or information.

### Example Operations

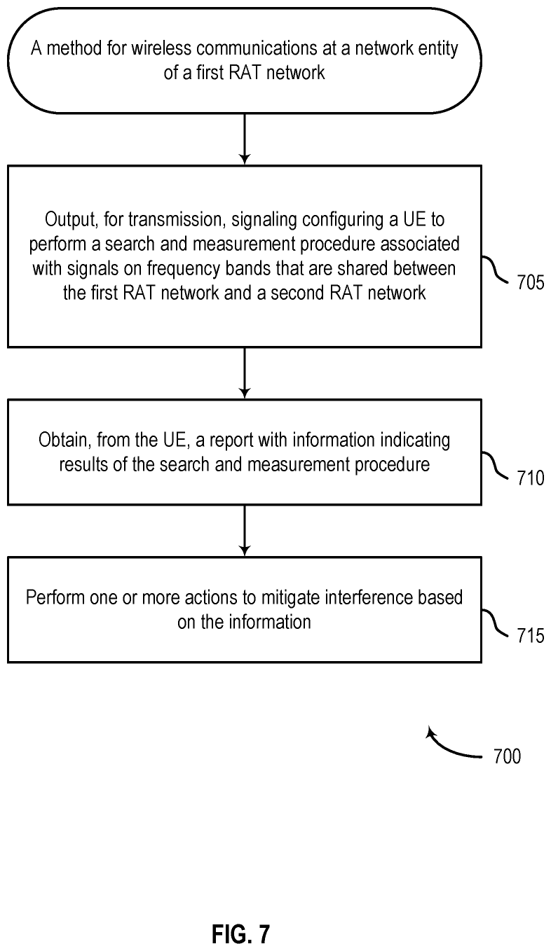

FIG. 7 shows an example of a method 700 of wireless communication at a network entity of a first RAT network, such as a BS 102 of FIGS. 1 and 3, or a disaggregated base station as discussed with respect to FIG. 2.

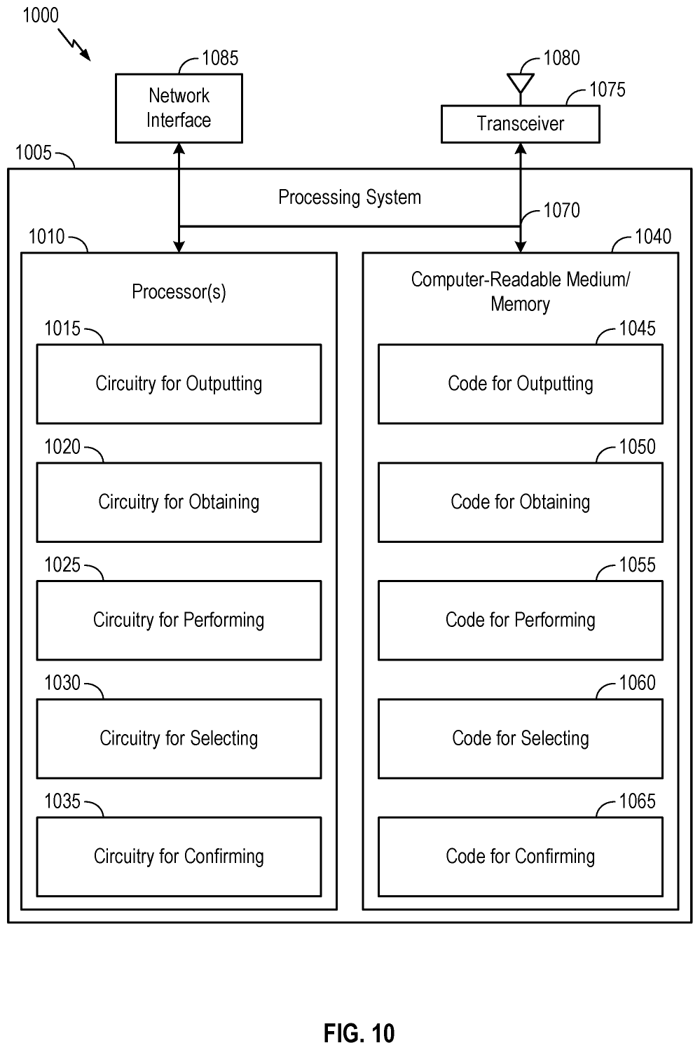

Method 700 begins at step 705 with outputting, for transmission, signaling configuring a UE to perform a search and measurement procedure associated with signals on frequency bands that are shared between the first RAT network and a second RAT network. In some cases, the operations of this step refer to, or may be performed by, circuitry for outputting and/or code for outputting as described with reference to FIG. 10.

Method 700 then proceeds to step 710 with obtaining, from the UE, a report with information indicating results of the search and measurement procedure. In some cases, the operations of this step refer to, or may be performed by, circuitry for obtaining and/or code for obtaining as described with reference to FIG. 10.

Method 700 then proceeds to step 715 with performing one or more actions to mitigate interference based on the information. In some cases, the operations of this step refer to, or may be performed by, circuitry for performing and/or code for performing as described with reference to FIG. 10.

In some aspects, the first RAT network comprises a WWAN; and the second RAT network comprises a WLAN.

In some aspects, the frequency bands that are shared between the first RAT network and the second RAT network include frequency bands above 6 GHz.

In some aspects, the report identifies one or more signals on the frequency bands that are shared between the first RAT network and the second RAT network.

In some aspects, the one or more signals identified in the report comprise SSBs.

In some aspects, the report includes information conveyed in SSBs that is associated with network entities of the second RAT network that operate on the frequency bands that are shared between the first RAT network and the second RAT network.

In some aspects, the information conveyed in the SSBs comprises at least one of: a cell number, a frame index, MIB information, or other SI.

In some aspects, the signaling further configures the UE to asynchronously report the information indicating results of the search and measurement procedure.

In some aspects, performing one or more actions to mitigate interference based on the information involves at least one of: allocating frequency resources to the UE; adjusting transmission power of at least one of the UE or the network entity; terminating a connection with the UE on a frequency band shared between the first RAT network and the second RAT network; or avoiding one or more frequency bands for an amount of time.

In some aspects, performing the one or more actions to mitigate interference is also based on at least one of: measured RSSI, RSRP, or SINR; velocity or movement of the UE; or data obtained from sources other than the UE.

In one aspect, method 700, or any aspect related to it, may be performed by an apparatus, such as communications device 1000 of FIG. 10, which includes various components operable, configured, or adapted to perform the method 700. Communications device 1000 is described below in further detail.

Note that FIG. 7 is just one example of a method, and other methods including fewer, additional, or alternative steps are possible consistent with this disclosure.

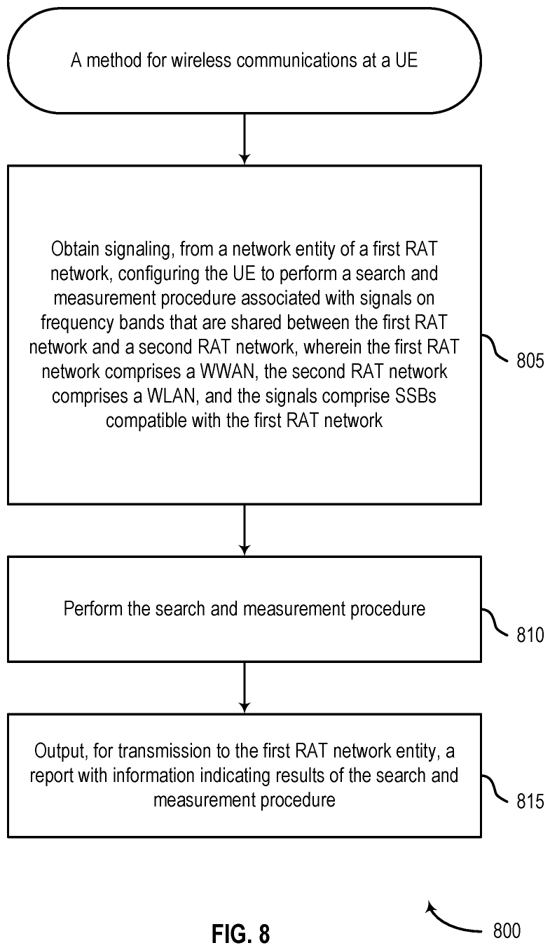

FIG. 8 shows an example of a method 800 of wireless communication at a UE, such as a UE 104 of FIGS. 1 and 3.

Method 800 begins at step 805 with obtaining signaling, from a network entity of a first RAT network, configuring the UE to perform a search and measurement procedure associated with signals on frequency bands that are shared between the first RAT network and a second RAT network, wherein the first RAT network comprises a WWAN, the second RAT network comprises a WLAN, and the signals comprise SSBs compatible with the first RAT network. In some cases, the operations of this step refer to, or may be performed by, circuitry for obtaining and/or code for obtaining as described with reference to FIG. 10.

Method 800 then proceeds to step 810 with performing the search and measurement procedure. In some cases, the operations of this step refer to, or may be performed by, circuitry for performing and/or code for performing as described with reference to FIG. 10.

Method 800 then proceeds to step 815 with outputting, for transmission to the first RAT network entity, a report with information indicating results of the search and measurement procedure. In some cases, the operations of this step refer to, or may be performed by, circuitry for outputting and/or code for outputting as described with reference to FIG. 10.

In some aspects, the frequency bands that are shared between the first RAT network and the second RAT network comprise frequency bands include frequency bands above 6 GHz.

In some aspects, the report identifies one or more signals, sensed by the UE, on the frequency bands that are shared between the first RAT network and the second RAT network.

In some aspects, the report includes information conveyed in the SSBs that is associated with second RAT network entities that operate on the frequency bands that are shared between the first RAT network and the second RAT network.

In some aspects, the information conveyed in the SSBs comprises at least one of: a cell number, a frame index, MIB information, or other SI.

In some aspects, outputting the report for transmission comprises outputting the report for transmission asynchronously.

In one aspect, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative steps are possible consistent with this disclosure.

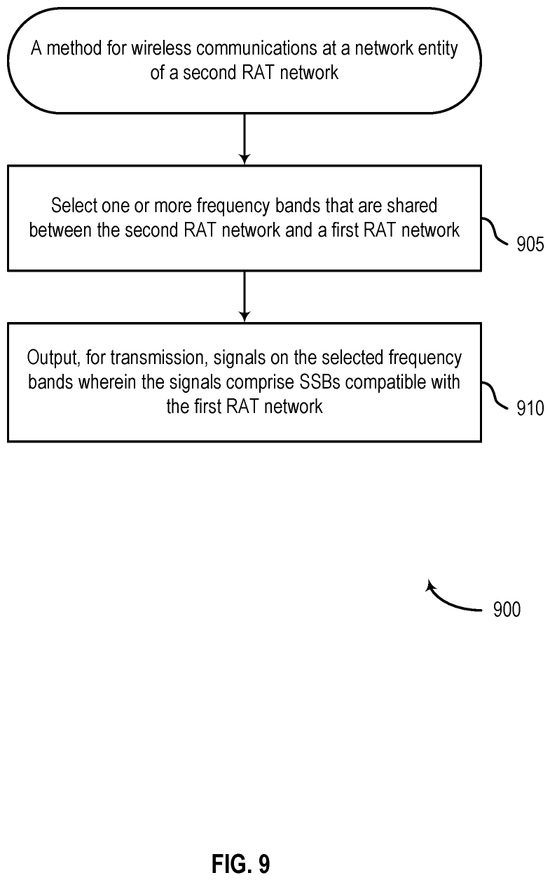

FIG. 9 shows an example of a method 900 of wireless communication at a network entity of a second RAT network, such as a BS 102 of FIGS. 1 and 3, or a disaggregated base station as discussed with respect to FIG. 2.

Method 900 begins at step 905 with selecting one or more frequency bands that are shared between the second RAT network and a first RAT network. In some cases, the operations of this step refer to, or may be performed by, circuitry for selecting and/or code for selecting as described with reference to FIG. 10.

Method 900 then proceeds to step 910 with outputting, for transmission, signals on the selected frequency bands wherein the signals comprise SSBs compatible with the first RAT network. In some cases, the operations of this step refer to, or may be performed by, circuitry for outputting and/or code for outputting as described with reference to FIG. 10.

In some aspects, the first RAT network comprises a WWAN network; and the second RAT network comprises a WLAN network.

In some aspects, the frequency bands that are shared between the first RAT network and the second RAT network comprise frequency bands above 6 GHz.

In some aspects, the signals include information conveyed in the SSBs that is associated with second RAT network entities operable on the shared frequency bands.

In some aspects, the information conveyed in the SSBs comprises at least one of: a cell number, a frame index, MIB information, or other SI.

In some aspects, the SSBs are output for transmission periodically at start times being based on system timing.

In some aspects, the SSBs are output for transmission using at least one of: FDM; or fixed waveforms.

In some aspects, the method 900 further includes confirming one or more channel access conditions are satisfied before outputting the signals for transmission. In some cases, the operations of this step refer to, or may be performed by, circuitry for confirming and/or code for confirming as described with reference to FIG. 10.

In one aspect, method 900, or any aspect related to it, may be performed by an apparatus, such as communications device 1000 of FIG. 10, which includes various components operable, configured, or adapted to perform the method 900. Communications device 1000 is described below in further detail.

Note that FIG. 9 is just one example of a method, and other methods including fewer, additional, or alternative steps are possible consistent with this disclosure.

### Example Communications Device

FIG. 10 depicts aspects of an example communications device 1000. In some aspects, communications device 1000 is a user equipment, such as UE 104 described above with respect to FIGS. 1 and 3. In some aspects, communications device 1000 is a network entity, such as BS 102 of FIGS. 1 and 3, or a disaggregated base station as discussed with respect to FIG. 2.

The communications device 1000 includes a processing system 1005 coupled to the transceiver 1075 (e.g., a transmitter and/or a receiver). In some aspects (e.g., when communications device 1000 is a network entity), processing system 1005 may be coupled to a network interface 1085 that is configured to obtain and send signals for the communications device 1000 via communication link(s), such as a backhaul link, midhaul link, and/or fronthaul link as described herein, such as with respect to FIG. 2. The transceiver 1075 is configured to transmit and receive signals for the communications device 1000 via the antenna 1080, such as the various signals as described herein. The processing system 1005 may be configured to perform processing functions for the communications device 1000, including processing signals received and/or to be transmitted by the communications device 1000.

The processing system 1005 includes one or more processors 1010. In various aspects, the one or more processors 1010 may be representative of one or more of receive processor 358, transmit processor 364, TX MIMO processor 366, and/or controller/processor 380, as described with respect to FIG. 3. In various aspects, one or more processors 1010 may be representative of one or more of receive processor 338, transmit processor 320, TX MIMO processor 330, and/or controller/processor 340, as described with respect to FIG. 3. The one or more processors 1010 are coupled to a computer-readable medium/memory 1040 via a bus 1070. In certain aspects, the computer-readable medium/memory 1040 is configured to store instructions (e.g., computer-executable code) that when executed by the one or more processors 1010, cause the one or more processors 1010 to perform the method 700 described with respect to FIG. 7, or any aspect related to it; the method 800 described with respect to FIG. 8, or any aspect related to it; and the method 900 described with respect to FIG. 9, or any aspect related to it. Note that reference to a processor performing a function of communications device 1000 may include one or more processors 1010 performing that function of communications device 1000.

In the depicted example, computer-readable medium/memory 1040 stores code (e.g., executable instructions), such as code for outputting 1045, code for obtaining 1050, code for performing 1055, code for selecting 1060, and code for confirming 1065. Processing of the code for outputting 1045, code for obtaining 1050, code for performing 1055, code for selecting 1060, and code for confirming 1065 may cause the communications device 1000 to perform the method 700 described with respect to FIG. 7, or any aspect related to it; the method 800 described with respect to FIG. 8, or any aspect related to it; and the method 900 described with respect to FIG. 9, or any aspect related to it.

The one or more processors 1010 include circuitry configured to implement (e.g., execute) the code stored in the computer-readable medium/memory 1040, including circuitry for outputting 1015, circuitry for obtaining 1020, circuitry for performing 1025, circuitry for selecting 1030, and circuitry for confirming 1035. Processing with circuitry for outputting 1015, circuitry for obtaining 1020, circuitry for performing 1025, circuitry for selecting 1030, and circuitry for confirming 1035 may cause the communications device 1000 to perform the method 700 described with respect to FIG. 7, or any aspect related to it; the method 800 described with respect to FIG. 8, or any aspect related to it; and the method 900 described with respect to FIG. 9, or any aspect related to it.

Various components of the communications device 1000 may provide means for performing the method 700 described with respect to FIG. 7, or any aspect related to it; the method 800 described with respect to FIG. 8, or any aspect related to it; and the method 900 described with respect to FIG. 9, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1075 and the antenna 1080 of the communications device 1000 in FIG. 10. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1075 and the antenna 1080 of the communications device 1000 in FIG. 10. Means for obtaining, means for outputting, means for performing, means for allocating, means for adjusting, means for terminating, means for avoiding, and means for selecting may include any of the process described above with reference signals.

### Example Clauses

Implementation examples are described in the following numbered clauses:

Clause 1: A method for wireless communications at a network entity of a first RAT network, comprising: outputting, for transmission, signaling configuring a UE to perform a search and measurement procedure associated with signals on frequency bands that are shared between the first RAT network and a second RAT network; obtaining, from the UE, a report with information indicating results of the search and measurement procedure; and performing one or more actions to mitigate interference based on the information.

Clause 2: The method of Clause 1, wherein the first RAT network comprises a WWAN; and the second RAT network comprises a WLAN.

Clause 3: The method of any one of Clauses 1 and 2, wherein the frequency bands that are shared between the first RAT network and the second RAT network include frequency bands above 6 GHz.

Clause 4: The method of any one of Clauses 1-3, wherein the report identifies one or more signals on the frequency bands that are shared between the first RAT network and the second RAT network.

Clause 5: The method of Clause 4, wherein the one or more signals identified in the report comprise SSBs.

Clause 6: The method of any one of Clauses 1-5, wherein the report includes information conveyed in SSBs that is associated with network entities of the second RAT network that operate on the frequency bands that are shared between the first RAT network and the second RAT network.

Clause 7: The method of Clause 6, wherein the information conveyed in the SSBs comprises at least one of: a cell number, a frame index, MIB information, or other SI.

Clause 8: The method of any one of Clauses 1-7, wherein the signaling further configures the UE to asynchronously report the information indicating results of the search and measurement procedure.

Clause 9: The method of any one of Clauses 1-8, wherein performing one or more actions to mitigate interference based on the information involves at least one of: allocating frequency resources to the UE; adjusting transmission power of at least one of the UE or the network entity; terminating a connection with the UE on a frequency band shared between the first RAT network and the second RAT network; or avoiding one or more frequency bands for an amount of time.

Clause 10: The method of any one of Clauses 1-9, wherein performing the one or more actions to mitigate interference is also based on at least one of: measured RSSI, RSRP, or SINR; velocity or movement of the UE; or data obtained from sources other than the UE.

Clause 11: A method for wireless communications at a UE, comprising: obtaining signaling, from a network entity of a first RAT network, configuring the UE to perform a search and measurement procedure associated with signals on frequency bands that are shared between the first RAT network and a second RAT network, wherein the first RAT network comprises a WWAN, the second RAT network comprises a WLAN, and the signals comprise SSBs compatible with the first RAT network; performing the search and measurement procedure; and outputting, for transmission to the first RAT network entity, a report with information indicating results of the search and measurement procedure.

Clause 12: The method of Clause 11, wherein the frequency bands that are shared between the first RAT network and the second RAT network comprise frequency bands include frequency bands above 6 GHz.

Clause 13: The method of any one of Clauses 11 and 12, wherein the report identifies one or more signals, sensed by the UE, on the frequency bands that are shared between the first RAT network and the second RAT network.

Clause 14: The method of any one of Clauses 11-13, wherein the report includes information conveyed in the SSBs that is associated with second RAT network entities that operate on the frequency bands that are shared between the first RAT network and the second RAT network.

Clause 15: The method of Clause 14, wherein the information conveyed in the SSBs comprises at least one of: a cell number, a frame index, MIB information, or other SI.

Clause 16: The method of any one of Clauses 11-15, wherein outputting the report for transmission comprises outputting the report for transmission asynchronously.

Clause 17: A method for wireless communications at a network entity of a second RAT network, comprising: selecting one or more frequency bands that are shared between the second RAT network and a first RAT network; and outputting, for transmission, signals on the selected frequency bands wherein the signals comprise SSBs compatible with the first RAT network.

Clause 18: The method of Clause 17, wherein the first RAT network comprises a WWAN network; and the second RAT network comprises a WLAN network.

Clause 19: The method of any one of Clauses 17 and 18, wherein the frequency bands that are shared between the first RAT network and the second RAT network comprise frequency bands above 6 GHz.

Clause 20: The method of any one of Clauses 17-19, wherein the signals include information conveyed in the SSBs that is associated with second RAT network entities operable on the shared frequency bands.

Clause 21: The method of Clause 20, wherein the information conveyed in the SSBs comprises at least one of: a cell number, a frame index, MIB information, or other SI.

Clause 22: The method of any one of Clauses 17-21, wherein the SSBs are output for transmission periodically at start times being based on system timing.

Clause 23: The method of any one of Clauses 17-22, wherein the SSBs are output for transmission using at least one of: FDM; or fixed waveforms.

Clause 24: The method of any one of Clauses 17-23, further comprising: confirming one or more channel access conditions are satisfied before outputting the signals for transmission.

Clause 25: An apparatus, comprising: a memory comprising executable instructions; and a processor configured to execute the executable instructions and cause the apparatus to perform a method in accordance with any one of Clauses 1-24.

Clause 26: An apparatus, comprising means for performing a method in accordance with any one of Clauses 1-24.

Clause 27: A non-transitory computer-readable medium comprising executable instructions that, when executed by a processor of an apparatus, cause the apparatus to perform a method in accordance with any one of Clauses 1-24.

Clause 28: A computer program product embodied on a computer-readable storage medium comprising code for performing a method in accordance with any one of Clauses 1-24.

Clause 29: A network entity, comprising: at least one transceiver; a memory comprising instructions; and one or more processors configured to execute the instructions and cause the network entity to perform a method in accordance with any one of Clauses 1-10, wherein the at least one transceiver is configured to receive the report.

Clause 30: A user equipment (UE), comprising: at least one transceiver; a memory comprising instructions; and one or more processors configured to execute the instructions and cause the UE to perform a method in accordance with any one of Clauses 11-16, wherein the at least one transceiver is configured to transmit the report.

Clause 31: A network entity, comprising: at least one transceiver; a memory comprising instructions; and one or more processors configured to execute the instructions and cause the network entity to perform a method in accordance with any one of Clauses 17-24, wherein the at least one transceiver is configured to transmit the signals.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus, comprising: a memory comprising executable instructions; and a processor configured to execute the executable instructions and cause the apparatus to:
output, for transmission, signaling configuring a user equipment (UE) to perform a search and measurement procedure associated with signals on frequency bands that are shared between a first radio access technology (RAT) network and a second RAT network;
obtain, from the UE, a report with information indicating results of the search and measurement procedure; and
perform one or more actions to mitigate interference based on the information.

2. The apparatus of claim 1, wherein:
the first RAT network comprises a wireless wide area network (WWAN); and
the second RAT network comprises a wireless local area network (WLAN).

3. The apparatus of claim 1, wherein the frequency bands that are shared between the first RAT network and the second RAT network include frequency bands above 6 GHz.

4. The apparatus of claim 1, wherein the report identifies one or more signals on the frequency bands that are shared between the first RAT network and the second RAT network.

5. The apparatus of claim 4, wherein the one or more signals identified in the report comprise synchronization signal blocks (SSBs).

6. The apparatus of claim 1, wherein the report includes information conveyed in synchronization signal blocks (SSBs) that is associated with network entities of the second RAT network that operate on the frequency bands that are shared between the first RAT network and the second RAT network.

7. The apparatus of claim 6, wherein the information conveyed in the SSBs comprises at least one of:
a cell number, a frame index, master information block (MIB) information, or other system information (SI).

8. The apparatus of claim 1, wherein the signaling further configures the UE to asynchronously report the information indicating results of the search and measurement procedure.

9. The apparatus of claim 1, wherein the one or more actions involve at least one of:
allocating frequency resources to the UE;
adjusting transmission power of at least one of the UE or a network entity;
terminating a connection with the UE on a frequency band shared between the first RAT network and the second RAT network; or
avoiding one or more frequency bands for an amount of time.

10. The apparatus of claim 1, wherein the performance of the one or more actions to mitigate interference is also based on at least one of:
measured signal strength indicator (RSSI), reference signal received power (RSRP), or signal to interference and noise ratio (SINR);
velocity or movement of the UE; or
data obtained from sources other than the UE.

11. The apparatus of claim 1, further comprising at least one transceiver, wherein:
the transceiver is configured to transmit the signaling configuring the UE and to receive the report; and
the apparatus is configured as a network entity.

12. An apparatus, comprising: a memory comprising executable instructions; and a processor configured to execute the executable instructions and cause the apparatus to:
obtain signaling, from a network entity of a first radio access technology (RAT) network, configuring the apparatus to perform a search and measurement procedure associated with signals on frequency bands that are shared between the first RAT network and a second RAT network, wherein the first RAT network comprises a wireless wide area network (WWAN), the second RAT network comprises a wireless local area network (WLAN), and the signals comprise synchronization signal blocks (SSBs) compatible with the first RAT network;
perform the search and measurement procedure; and
output, for transmission to the first RAT network entity, a report with information indicating results of the search and measurement procedure.

13. The apparatus of claim 12, wherein the frequency bands that are shared between the first RAT network and the second RAT network comprise frequency bands include frequency bands above 6 GHz.

14. The apparatus of claim 12, wherein the report identifies one or more signals, sensed by a user equipment (UE), on the frequency bands that are shared between the first RAT network and the second RAT network.

15. The apparatus of claim 12, wherein the report includes information conveyed in the SSBs that is associated with second RAT network entities that operate on the frequency bands that are shared between the first RAT network and the second RAT network.

16. The apparatus of claim 15, wherein the information conveyed in the SSBs comprises at least one of:
a cell number, a frame index, master information block (MIB) information, or other system information (SI).

17. The apparatus of claim 12, wherein the report is output for transmission asynchronously.

18. The apparatus of claim 1, further comprising at least one transceiver, wherein:
the transceiver is configured to receive the signaling and transmit the report; and
the apparatus is configured as a user equipment (UE).

19. An apparatus, comprising: a memory comprising executable instructions; and a processor configured to execute the executable instructions and cause the apparatus to:
select one or more frequency bands that are shared between a second radio access technology (RAT) network and a first RAT network; and
output, for transmission, signals on the selected frequency bands wherein the signals comprise synchronization signal blocks (SSBs) compatible with the first RAT network.

20. The apparatus of claim 19, wherein:
the first RAT network comprises a wireless wide area network (WWAN) network; and
the second RAT network comprises a wireless local area network (WLAN) network.

21. The apparatus of claim 19, wherein the frequency bands that are shared between the first RAT network and the second RAT network comprise frequency bands above 6 GHz.

22. The apparatus of claim 19, wherein the signals include information conveyed in the SSBs that is associated with second RAT network entities operable on the shared frequency bands.

23. The apparatus of claim 22, wherein the information conveyed in the SSBs comprises at least one of:
a cell number, a frame index, master information block (MIB) information, or other system information (SI).

24. The apparatus of claim 19, wherein the SSBs are output for transmission periodically at start times being based on system timing.

25. The apparatus of claim 19, wherein the SSBs are output for transmission using at least one of:
frequency division multiplexing (FDM); or
fixed waveforms.

26. The apparatus of claim 19, further comprising at least one transceiver, wherein:
the transceiver is configured to transmit the signals; and
the apparatus is configured as a network entity.
